(19) United States
(12) Patent Application Publication
(10) Pub. No.: US 2010/0110195 A1
(43) Pub. Date: May 6, 2010

(54) VIDEO IMAGERY DISPLAY SYSTEM AND METHOD

(76) Inventor: John Richard Mcintosh, Birmingham (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/530,353

(22) PCT Filed: Mar. 7, 2008
(86) PCT No.: PCT/GB08/00787

§ 371 Date: Oct. 23, 2009

(30) Foreign Application Priority Data
Mar. 8, 2007 (GB) 0704421.7

(51) Int. Cl. H04N 7/18; H04N 7/26; H04N 7/16

(52) U.S. Cl. 348/157; 386/109; 725/25; 348/E07.085; 386/E05.003

(57) ABSTRACT

A system of apparatus arranged to display upon request video imagery stored in a video archive, the system comprising: (a) a plurality of cameras able to capture video images; (b) primary video compression means adapted to compress video images received from cameras (a); (c) video archiving programming means arranged to process video signals compressed by the compression means (b); (d) video archiving means arranged to store compressed said video signals; (e) secondary video compression means linked to the archiving means (d) and adapted to compress video imagery obtained from said archiving means (d) into a format selected from a mobile device format, web video format and TV video format; (f) server means adapted to said format and arranged to interrogate said archiving means (d), and capable of communication with (g) a remote mobile device, web browser or TV display controller and with (h) a gateway payment appropriate to said format, and in which archived video images are compressed and relayed to said server means (f) and subsequently to said mobile device, web browser or TV display controller (g) upon demand from said server means when triggered by a request from any of said remote mobile device, web browser or TV display controller (g) for specific video imagery once authorised by said payment means (h). A method of displaying video imagery upon a mobile device using apparatus as defined above, wherein (i) a text message comprising a unique identifier associated with specific video imagery to be displayed on said mobile device is relayed to server means adapted to mobile device format (f); (ii) the said server means (f) transfers a request to interrogate the video archiving means (d) and locate the required specific video imagery; (iii) the video archiving means (d) converts the specific video imagery to be compressed into a suitable format file for said mobile device; (iv) the compressed file obtained in step (iii) is relayed back to said server means (f); (v) payment for the specific video imagery requested is deducted from the mobile device user's account; (vi) indication of accepted payment is relayed to the said server means (f), and (vii) the requested specific video imagery is relayed to and displayed upon the said mobile device.

This invention is concerned with methods and systems of apparatus for displaying archived video imagery upon fee paying request. Readers will be familiar with televised major spectator events such as sporting events including football matches. Television images are broadcast live to many television receivers, or are stored for transmission and replay after the event.

During major spectator sporting events such as football matches however, the live or replayed images focus mainly upon the players and the ball during play. At a major spectator event such as but without limitation to sporting events like football matches, a limited range of ‘memorabilia’ are available to the visiting fans for purchase and retention. For example, fans can buy pictures, photographs, caps, scarves and posters depicting the club, teams or players and there is a reasonable market in the sale of such memorabilia. However, not currently available are images of fans' reactions to memorable events in the facial and/or body expressions of the fans reflecting the nature of the event. Typically there will be expressions of joy by selected fans when their team scores a goal or wins the match. Equally there will be expressions of sadness when, for example, a goal is scored by the opposing team or a key player in the fan's team is sent off. There will also be expressions of apprehension in the lead up to a penalty or penalty shoot out, which may alter to expressions of joy or celebration. The present inventor has identified a prospective market in the capture and subsequent replay of the expressions of spectators at significant events, such as the expressions of fans watching a football match (or groups of fans such as a group of friends or family). To this extent the present inventor brings additional useful ‘memorabilia’ to that which is already available, but in the form of archived video images that can be replayed for enjoyment, amusement or celebration. Thus a group of friends who attended a specific match can have images of their facial/body expressions replayed to them upon corresponding fee payment via mobile phone or other means.

In recent times there has been considerable development in mobile electronic devices such as mobile phones, capable of displaying video signals transmitted across the mobile network. Improvements in the resolution of display panels within such mobile devices means that video imagery of acceptable quality can be displayed repeatedly by such devices. There is a sizeable personal ownership of mobile devices such as mobile phones incorporating such display panels, and because of their portability and convenience they are frequently carried on the person.

For example given a collection of mutual friends discussing a football match, providing at least one has a mobile phone, then by keying in information containing a unique identifier associated with the timing of a particular recordable event, such as a goal and the location of the person or persons whose facial and/or body expression imagery is required, then video imagery of that person or persons who attended the event can be downloaded upon corresponding fee payment, to that mobile phone and replayed to that person or other persons in such a group of friends for enjoyment or celebration.

Instead of such imagery being imagery of the match such as of the players and/or ball or non specific images of the crowd, it has now been ascertained that video imagery of e.g. the facial and/or body expressions of persons attending the event especially during significant moments in, e.g. a sporting event are saleable commodities of ‘memorabilia’ and as such can be made available to be displayed after the event in a reproducible manner upon payment of an appropriate fee.

The system and apparatus of the present invention can be deployed as a means of capturing ‘memorabilia’ images of the expressions of one or more persons who saw significant or otherwise memorable events such as goals, missed goals, penalties, referee cards, player send offs and the like in a football match. Such imagery may be kept for many years i.e. stored in an archive means and retrieved for redisplay if required weeks, months or even years after the event. It can be used as a means of capturing facial and/or body expressions during such significant events in archive means for subsequent retrieval and display upon demand, using appropriate interrogation, recall and display means. For example, transmission of the required imagery is preferably relayed on a fee paying on demand basis to a mobile phone, although fee-paying display to computer screen or TV screen as in interactive TV is also possible.

According to the present invention, in one aspect there is provided a system of apparatus arranged to display upon request video imagery stored in a video archive, the system comprising:
(a) a plurality of cameras able to capture video images;
(b) primary video compression means adapted to compress video images received from cameras (a);
(c) video archiving programming means arranged to process video signals compressed by the compression means (b);
(d) video archiving means arranged to store compressed said video signals;
(e) secondary video compression means linked to the archiving means (d) and adapted to compress video imagery obtained from said archiving means (d) into a format selected from a mobile device format, web video format and TV video format;
(f) server means adapted to said format and arranged to interrogate said archiving means (d), and capable of communication with (g) a remote mobile device, web browser or TV display controller and with (h) a payment gateway appropriate to said format, and in which system archived video images are compressed and relayed to said server means (f) and subsequently to said mobile device, web browser or TV display controller (g) upon demand from said server means when triggered by a request from any of said remote mobile device, web browser or TV display controller (g) for specific video imagery once authorised by said payment means (h).

In a second aspect the present invention further provides a method of displaying video imagery upon a mobile device using apparatus as defined above, wherein
(i) a text message comprising a unique identifier associated with specific video imagery to be displayed on said mobile device is relayed to server means adapted to mobile device format (f);
(ii) the said server means (f) transfers a request to interrogate the video archiving means (d) and locate the required specific video imagery;
(iii) the video archiving means (d) converts the specific video imagery to be compressed into a suitable format file for said mobile device;
(iv) the compressed file obtained in step (iii) is relayed back to said server means (f);
(v) payment for the specific video imagery requested is deducted from the mobile device user's account;
(vi) indication of accepted payment is relayed to the said server means (f), and
(vii) the requested specific video imagery is relayed to and displayed upon the said mobile device.

In the case of displaying selected video imagery to a web browser for display on a computer screen the server means can be a web server in communication with a web payment gateway and the said web browser.

In the case of a displaying selected video imagery to a TV (television) screen, the server means can be a TV Head End in communication with a TV payment gateway and the TV screen via a remote TV controller if required. Picture in picture would be particularly effective for presentation, such that the sports event fills the main screen and the behaviour of the chosen fans is overlaid in a small (picture in picture) window near a corner of the main screen.

Preferred and optional features of the invention are to be found amongst the subclaims.

There are three potential video imaging system structures which may be utilised in the present invention for capturing, archiving and replaying remotely on demand specific required video images. These are:

### (1) CCTV

### (2) Machine Vision

(3) Prosumer equipment

### Prosumer Equipment (3)

Professional consumer technology using digital video (DV) is an ideal format for PC or web based video. There are a range of camcorders/video cameras available on the market, and the camera selected in the present invention should reflect upon the video quality required and budget available.

PCs are sufficiently powerful to deal with the demands on the storage and performance required by video data processing. Currently available processors provide ample processing power to deal with video transfer, and the increases in storage capacity and reductions in the cost of RAM also serve DV technology well. There is strong native operating system support for digital video connectivity features such as firewire, and plug-and-play support for removable hard drives and DV camcorders.

The size of such professional video (or prosumer) cameras are less preferable from a physical standpoint, which reduces their feasibility. In addition to this, the cameras require manual operation by a human, which offers further challenges from two perspectives. Firstly, stationing a person on each individual camera would introduce incremental costs in terms of manpower, and secondly, the positioning of camera operators on the stands would potentially block the view of spectators and present health and safety risks to many.

### Machine Vision (2)

Machine vision engineering embraces computer science, optics, mechanical engineering, and industrial automation. Machine vision systems now use digital cameras, smart cameras and image processing software to perform similar inspections.

Such systems are typically programmed to perform tasks such as counting objects on a conveyor belt, reading serial numbers, and searching for surface defects. As much (if not all) of the present system will require a high degree of automation, machine vision is a potential solution.

The chief advantage of implementing a machine vision system for the present invention is massively to reduce or remove the need for human intervention in a process, or to remove human error which may otherwise occur without automation. Considering that as few as one person may be required physically to operate/supervise the cameras after installation, significant automation of anything on the acquisition side is less desirable. The extent to which automation could be utilised in the present invention is vast, however it will be mainly required in the area of network communications and not image processing. In fact any adjustments required during a match would generally benefit more from subjective human judgement than any pre-defined computer system.

The only human intervention required with this system would be to adjust manual settings on the cameras according to lighting levels or weather, a more manual task in any case.

### CCTV (1)

Closed Circuit Televisions (CCTV) is an isolated system in that all of the circuits contained within it are closed and directly connected. This is contrasting to broadcast television where the signals are accessed by specialist receiving equipment that is tuned to collect signals from across the airwaves.

CCTV systems are progressively finding applications outside of the security industry and are now used broadly in monitoring and control applications, though there is no evidence of a commercial application at public events at present. Although the proposed scale of the present invention is vast, CCTV systems are inherently scalable, so a smaller scale installation can be deployed in larger stadiums given adequate increase in hardware resources. Consequently, increasing the capacity of the system would be relatively simple with this means of capturing and archiving video imagery, for subsequent replay remotely on demand.

Although every CCTV system exists as a self-contained unit, the level of native control and integration is unmatched by the aforementioned potential applications. The fact that such CCTV solutions are naturally and routinely built as part of a networked system leads to the CCTV application as the most preferred system for capturing and archiving video imagery.

Networked CCTV systems generally incorporate a high degree of automation in communications technology.

Any CCTV solution adopted can remain independent of stadium CCTV (which has uncompromisable duties) and can play a principal role in wider networks.

### Essential Devices

Although the application and range of devices used in a CCTV system is diverse, all contain a number of essential components. Each must be compatible and work together within the present invention in an efficient way to operate effectively. These core components are:
(a) Camera
(b) Lens
(c) Cables
(d) Recording and monitoring equipment
(e) Lighting/illumination

### Video Cameras

The primary purpose of the camera is to project images onto sensors using light and lenses. There are a number of factors to consider when selecting a camera for the present invention, including the environment, weather, potential for damage and lighting levels. These variables will be balanced against the requirement to resolve detail in the picture so that the output video files are clear and of high quality for the end user. There are several categories of CCTV cameras (some cameras may hold one or more of the below properties):

### Monochrome Cameras

Black and white cameras offer higher quality video compared with colour cameras in environments with poor lighting. They can also be matched to infra red (IR) illumination invisible to the human eye. This is a suitable option for stadiums where lighting in the stand is poor and restrictions limit or exclude installation of significant lighting rigging and equipment above crowd areas.

### Colour Cameras

Colour is of major importance for most recorded video media, and colour cameras provide representations of images in full colour. Installing a camera which offers colour images is most preferred in the present invention as most fans will not desire to purchase videos in black and white.

### Colour/Monochrome Cameras

These are multi-purpose cameras which operate well in environments which are both well and poorly lit. These provide high quality colour images in regular light conditions, switching from colour to black and white mode when the light levels become low. This is also a preferred option in the present invention offering maximum flexibility should lighting levels be reduced for some unforeseen reason.

### Dome Cameras

Cameras can be contained within a transparent plastics dome for protection and to disguise the direction in which the device is pointing. Since the cameras may be the target of projectiles being thrown from the crowd, using a dome camera is highly preferred to protect the many cameras located all around the stadiums.

### IR Colour/Mono Cameras

These are designed for high performance in conditions where the environment is almost permanently subject to poor illumination. IR Colour/Mono Cameras are a unit consisting of a camera and lens, plus an integral infra red (IR) light emitting diode (LED) array assembly unit. Any part of the stand, from which specific required video images are to be taken, which is permanently subject to poor illumination is better remedied by additional lighting rather than seeking to address the problem through the camera.

The below CCTV camera types are potentially useful in acquiring video footage for the present invention.

### Internal Dome

A high resolution colour dome camera with 3-9 mm Vari-focal lens, powered by 12VDC or 24Vac. This camera is only suitable for indoor environments.

### Vandal Resistant Dome

A high resolution vandal resistant colour dome camera with 3-9 mm Vari-focal lens, powered by 12VDC or 24Vac. Suitable for both internal and external environments.

### All in One Camera

High resolution colour camera with 2.8-10 mm vari-focal lens 12VDC or 24Vac for internal use including cable managed wall bracket.

### Colour Kit

Pre-built external camera kit including high resolution colour camera with 2.8-12 mm vari-focal auto iris lens. Predominantly used for exteriors, includes camera housing and wall bracket.

### Day/Night Kit

Pre-built external camera kit including high resolution day/night camera. 3.5-10.5 mm vari-focal auto iris lens. Predominantly used for exteriors, includes camera housing and wall bracket.

### Nightvision Kit

Pre-built external camera kit including high resolution day/night camera 3.5-10.5 mm van-focal auto iris lens with exterior camera housing. The kit will produce high resolution colour images during the day and high resolution mono images in total darkness and will cover distances up to 30 m+ in complete darkness.

### Lenses

A lens is an optical device attached to the camera used to focus light from the front of the camera to the electronic sensors within.

The focal length of the lens is directly related to the angle of view or scene. Short focal lengths give a wide angle of view. As the focal length increases the view of the camera becomes narrow. A standard angle of view is similar to what is seen by the human eye (roughly 35°).

There are three main categories which all lenses fall into:

### Fixed Focus Lens

These have a fixed focal length and are used when the angle of view is not intended to be altered or adjusted. It is the most basic form of CCTV camera lens. These lenses are much cheaper than the other options and can significantly reduce the cost of this system component.

### Vari-Focal Lens

This type of lens allows the focal length to be manually adjusted slightly during the installation. It allows for the field of view or scene to be altered to a small extent during set-up which allows a limited margin of error.

### Zoom (Telephoto) Lens

Has a long focal length to produce high magnification but a narrow angle of view. The manual zoom lens offers a wide adjustment at setup. The motorised zoom lens is used by an operator to automatically change the field of view to zoom in and out on a target. These lenses are the most expensive and would significantly increase the cost of this system component.

### Irises

The final video quality will be largely influenced by the natural light available to the lens at the scene, and by any artificial illumination that must be provided when natural light is not available. Therefore to get the best image quality it is vital that the correct amount of light reaches the camera sensor via the lens. In practice this is regulated by the lens iris.

### Auto Iris Lens

These automatically adjust to changes in the lighting levels so are most widely used in external applications and environments subject to regular changes in light levels. This is an ideal iris for the present invention as it is often impossible to specify precisely the levels of lighting which will be present at a given event.

### Aspherical Lens

These have special optics and achieve better sensitivity with cameras used in low lighting environments. The aspherical lens gives increased performance when lighting conditions are poor, effectively giving a sharper, clearer image at dusk and at daybreak.

However this level of sophistication economically is not preferred as the auto iris is more preferred.

### Lighting

Lighting is essential to the recording of the video content as the camera will only pick up light reflected from the stand. When natural light is not available, artificial light must be provided since poor illumination will result in low quality video. Natural light may suffice during daytime matches, however evening events will likely require additional illumination, especially on isolated parts of the crowd.

Traditional CCTV installations achieve this through the use of general overt lighting or infrared (IR) covert illumination invisible to the human eye but monochrome camera detectable. However, any system using infrared video content is less preferred as consumers will ultimately have the expectation of seeing themselves in colour as opposed to black and white. Therefore the provision of lighting installed in the stands for potential evening matches is desirable.

Any such additional lighting installation should provide roughly even illumination across the scene. The CCTV cameras should not let the camera point into any light source directly, whether natural or artificial. Any artificial lighting should be tested to assess optimum lighting levels for evening kick offs at different times of the year, as colour temperature will fluctuate according to weather factors such as cloud coverage.

A balance is desired between providing adequate lighting for the cameras for a full colour image, and ensuring that the experience of the football match is not intruded upon.

An overview of preferred lighting options is given below:

Incandescent Lighting—This uses a filament such as those found in a general use electric light bulb. It is heated to the extent that it produces a white glow.

General filament Lighting: Acceptable for internal applications.

Tungsten Halogen: Good colour rendering but expensive to run.

Fluorescent Lighting—These produce an emission of light as a result of a gas discharge. Fluorescent lights offer good colour rendering and are more economic and therefore the most preferred lighting.

High Intensity Discharge (HID)—HID uses start up circuits and offer specialist lighting for reliable and consistent use over long periods. Start up periods and re-strike periods mean these illuminators should only be used with CCTV over protracted periods such as weeks. These lights are economic, but unsuitable for stadium events which do not last for such long periods.

Low pressure sodium (SOX)—The predominant source in urban street lighting. Unfortunately it cannot discriminate colours effectively in CCTV systems, meaning that it is not a preferred option.

High pressure sodium (SON) and Metal halide (HPI)—Both give good colour rendering in CCTV systems but can be expensive to implement.

LED illumination—LED technology for both white light and infra-red illumination. This type of lighting offers low running costs and extremely long life. However as mentioned previously, this lighting system is not preferred as colour images are required.

It is most preferred that fluorescent lighting should be used as additional lighting if required. It is likely that auxiliary lighting will be required for most stadiums to acquire good quality video content.

### Camera Selection

When selecting a preferred camera, a number of factors should be considered.
a) The cameras will be in very close proximity to thousands of fans, therefore it is preferred to choose a model which can sustain potential damage.
b) It can be assumed that fans will not want a mass of cameras overtly pointing in their direction for the entire event. Therefore it is preferred to use a camera which disguises the direction of the camera's view.
c) High resolution images are most preferred from the cameras to reproduce clear video on both computer monitors and after compression on mobile devices.
d) While infrared imaging may be a desirable additional feature in darker environments, it is not an essential component. Infrared images are reproduced in monochrome.

Using this criteria, the most preferred camera is the Vandal Resistant Dome. This conceals the direction in which the camera is pointing, offers higher durability, and offers maximum flexibility of both well/poorly lit environments.

### Number of Cameras Required

Taking Aston Villa's stadium, Villa Park, as an example, some approximate calculations will be made to evaluate the number of cameras required to cover the capacity of the stadium. These do not consider logistics and placement of the cameras as this is an arbitrary consideration which will vary in every stadium. Precise calculations can only be obtained from gaining entry to each stadium and conducting a thorough assessment on each stand.

Villa Park has a capacity of 42,573. Assuming that one camera would satisfactorily cover 100 people (ten rows and ten columns of fans), then 426 cameras will be required for this stadium. If the 90,000 capacity Wembley Stadium is used as a venue for application of the present invention then 900 cameras will be required to cover that facility.

### Video Delivery

Delivering video across the internet/mobile networks requires significant compression, to reduce delivery bandwidth requirements and costs associated with large video files. It is used to eliminate redundancies in data and can reduce the size of a file by a factor of 100 or more in many cases. For example, a 150 megabyte video might be reduced to 1.5 megabytes whilst still retaining the fundamental information required for human perception and interpretation.

### Codecs and Formats

In order to reach the widest possible mobile audience, it is desirable to consider encoding the mobile videos in a variety of codecs and formats. Just as Internet-based content providers face the dilemma of which formats to offer their video content in, the mobile market is equally as, if not more, fragmented.

Unfortunately mobile phones have a major drawback: unlike PC-based offerings where it is possible for the user to download additional software to view the content, mobile phones are fairly limited in CPU and memory, so application downloading is not widespread. Users (especially those who are technologically averse) generally assume that whatever they need to access video will be preloaded on the phone. Not all phones in the marketplace today have native support for video playback, but mobile operators usually measure the average life of a mobile phone in months, not years. Updated software can and does make it into the marketplace in shorter cycles than for embedded systems.

The prevalent codecs and formats in today's marketplace are broken into three categories: mobile standards, vendor standards, and proprietary codecs.

### Standards Based Codecs

The main mobile standards are specified by 3GPP (3^{rd} Generation Partnership Project), a collaboration of several telecommunications standards bodies. The scope of 3GPP is not limited to multimedia; it provides specifications for most of today's GSM-based networks. For content providers, the series of 3GPP multimedia standards specifies the container for video content, as well as the supported video and audio codecs multiplexed within that container.

Modern phones use two primary video codecs: H.263 and MPEG-4. H.263 is used in most videoconferencing appliances. This codec offers extremely low latency, making it well suited for live applications. The CPU requirements for decoding are also extremely light, matching well with the CPU power inside of modern phones. H.263, however, is not considered a modern codec, and when compared with the other codecs available, it is extremely bandwidth-inefficient.

MPEG-4, or more specifically MPEG-4 Simple Profile, is an equivalent of H.263. It has many of the same latency and decoding characteristics, with greater encoding efficiency and hence higher video quality. Most content providers in the mobile space are using MPEG-4 as their video codec for 3GPP content, which is currently the most preferred solution for the present invention for targeting as wide an audience as possible.

The most modern standards based codec is H.264, which is also known as advanced video coding. The content industry is using H.264 encoding for mobile devices and transmission of high-definition television networks. It has two to three times more encoding efficiency when compared with MPEG-2, the current broadcast industry standard. Hardware-based H.264 encoders are commercially available today, however support within mobile phones is not as prevalent at present. H.264 provides extraordinary image quality for a given data rate and is expected to have a player installed as standard for videophones in the near future.

Although H.264 is, in terms of video quality, the most preferred option it is advisable to encode in 3GPP video to ensure wide support for the current market.

### Vendor Formats

The two dominant vendor formats are RealNetworks' RealVideo and Microsoft's Windows Media codecs/formats. Windows Media is generally preloaded on phones and PDAs running either Pocket PC Phone Edition or Pocket PC 2003. RealNetwork's mobile player is available for Symbian, Palm OS, and Pocket PC phones. Some Nokia models (9200 series Communicators and the 3650 and 7650) have the software in their embedded systems.

Vendor formats provide the easiest entrance to the mobile market for content providers, as related software has long existed to produce compressed video at low bit rates since the early days of the internet. Some adjustments to the encoding parameters are required for mobile audiences, but overall the barrier to entry is much lower than the mobile standards or proprietary codecs. While Pocket PC and Palm-based phones are gaining market share, regular mobile phones make up the vast majority of devices in circulation, and the current prices of both will see this trend continue for the near future at least. Therefore using these codecs will help the present invention reach part of the potential audience.

### Proprietary Formats

The third category of formats and codecs is proprietary. Many of these are based on the J2ME virtual machine and are a viable way of providing video content to customers whose phones don't have native video support. The codecs themselves are optimized for low-bandwidth operations and decoding efficiency. Encoding content in these formats is carried out with tools provided by the codec vendor.

As identified, there are many codecs and formats, and no simple mechanism for choosing which ones to support. By definition, proprietary players and codecs require download onto the end users' phones, creating a higher barrier to entry and acceptance when compared with native functionality. This system would need to identify the audience not only by demographics, but also by the devices they carry. As such, it is not a preferred system for a football stadium.

### Delivery Mechanisms

Mobile video delivery can be divided into two categories: live streaming and VOD (video on demand). VOD is further classified into subcategories: TVOD (true video on demand), where the content is streamed to the phone in real time after being requested by the users; and download, where the content is downloaded to the device in its entirety before the fan (i.e. user of the present invention) can playback.

True Video on Demand/Streaming

TVOD presents problems in that the content is never stored by the mobile device, which is an issue because one of the advantages of the present invention is that the user can keep content for as long as they please.

TVOD also displays several disadvantages as far as mobile technology is concerned at present. To provide a satisfactory user experience, consistent bandwidth matching or exceeding the data rate of the video clip must be available on the user's mobile network. This is, in practice, very difficult to guarantee as data connectivity at a transmitter is a shared resource, so the collective consumption of bandwidth could have an adverse impact on the fans' experiences if this option was selected. This option is therefore less preferred.

### Mobile Video Download

Although it may take slightly longer to arrive, content download ensures a higher quality experience for the end user. In this scenario, every piece of content in the video is downloaded and stored in the phone's memory. Following successful download, the file playback is instant and not subject to the plight of potential network congestion. This allows for the possibility of viewing content even without having a connection to the network (no coverage area, tunnels, airplanes, etc.). It also allows for higher-quality video. Pushing a 128 Kbps file to the phone does not need to occur in realtime, so higher-data-rate files can be placed on the phone, providing for a much more positive user experience.

Although 128 Kbps seems reminiscent of the dial-up modem and ISDN era, given the screen sizes of today's phones (generally 176 by 144 pixels), it provides what users consider reasonable image quality and motion. The video generally has a lower frame rate than broadband PC-based streaming (8-10 on the phone vs. 15-30 on PC-based video), but the small screen combined with visual perceptions in the eye compensate for the lower rate, resulting in the appearance of better quality. This option is therefore preferred.

### The Future

Regarding storage capacity available on conventional mobile phones, many models are only sold with 32 to 64 MB of memory for video storage. Data rates of 128 Kbps allow for approximately 34 to 68 minutes of video to be stored on the phone. This is adequate to satisfy today's market, however as more mobile content providers enter the marketplace, it is possible that users may require more capacity to store further video content.

### Update Frequency

Updates to mobile phones are done in “carousel” fashion to provide equal distribution scheduling for competing content owners, with a complete update cycle often taking 30 minutes. This is generally not an issue for most applications.

### Mobile Operators

Providing a successful video offering to mobile devices requires co-ordination with and co-operation of mobile operators. Mobile-based Web sites can run without operator cooperation.

From a quality-of-service perspective, it's preferable to have the wireless operators service the request from the end user.

They are better equipped to route traffic appropriately within their networks, and they have the knowledge of their network infrastructures. Assuming availability of accurate usage information, the operator can ensure most efficient delivery of the content, and the fans get the best possible experience from having the content served topologically closest to them.

### Hardware Requirements

### Monitoring

The devices are used to view the image include monitor screens and may be traditional CRT screens or the new generation TFT/LCD screens. If more than one channel is to be viewed on the same screen, the size of the monitor will depend on the number of channels to be displayed at a given time, the viewing distance and the available space.

Monitoring is not essential after installation as the process can be automated. Aside from maintenance checking, regular monitoring of the crowd should not be required. A plurality of monitors are preferred to actively supervise the content, however the quantity opted for would depend e.g. on the stadium and number of cameras installed.

The viewing equipment may be complemented by slave monitors so that the footage from the cameras may be viewed at more than one location, and remotely if required. Monitors generally have two BNC connectors, where one is provided to accept the signal from the camera or the recording equipment and the other is to loop through to a slave monitor if required.

### Auxiliary Equipment

Alongside the camera control and recording equipment telemetry may be desirable. This is a signalling system used for the remote control of functions at the camera locations such as pan, tilt and zoom. The preferred cameras already possess these features, however a specialist keyboard is desirable to control these functions.

Preferably, a wash/wipe feature is present to clear the camera housing screen. In order to carry this out, signals could be generated at a controller keypad or joystick located close to the monitor. The signals could be sent to a receiver located adjacent to the camera head. This is a desirable feature as it's possible that the covers of the cameras may become affected by rain drops or items being thrown at them. Without appropriate telemetry, a person would have to tend to and clean each individual camera.

An appropriate keyboard for this purpose is the C-DKBD keyboard, providing excellent integration with both the camera and DVR unit selected.

### Storage

The amount of video compression selected depends upon required video quality and file size, which dictates the storage capacity required. The more a video is compressed, the lower the resolution/quality of the file. Conversely the less compression applied to a video, the higher the resolution/quality, as indicated in Table 1 below.

TABLE 1

| | Uncompressed | Heavily Compressed |
|---|---|---|
| Resolution/quality | High | Low |
| Storage space required | Large | Small |
| Data transfer speed | Slower | Faster |
| Delivery bandwidth cost | Very high/not | Low |
| | currently possible | |

Raw, untreated video data requires vast storage space where data rates of 1 GB per minute of footage are commonplace. Where the video imagery in the present invention is to be delivered exclusively over the internet/mobile networks, it is preferred to compress the data to a moderately compressed format before it is stored in the video repository to minimise storage requirements.

Formats such as the standards based MPEG-4 are now used widely in modern CCTV systems and this demonstrates the ability to massively reduce the size of video files while retaining video of high quality. Considering that significant storage capacity will be required, it is preferred to utilise a codec such as MPEG-4 to archive video content.

### Digital Video Recorder

The present system requires a Digital Video Recorder (DVR) to archive video content. In addition to acting as a storage device, DVRs operate as the controlling mechanism, recording the footage to built-in hard drive while transmitting to the monitoring equipment.

The preferred DVR would operate through ingesting a specified number of input channels to which e.g. the stadium cameras are connected. The array of camera feeds are transmitted to the monitoring system for viewing in the chosen method e.g. individually or on a multiscreen so that all images can be displayed simultaneously. This is highly preferred if more than one camera is to be viewed, or recorded, and shown on a single monitor screen. Captured video from e.g. the stadium can be replayed locally at the DVR through a monitor, or e.g. connected to a PC network for processing and transmission across the internet to the mobile server and onto the users' phones.

Current DVR technology provides solutions which are features rich and offer services that exceed the simple recording of video images previously available through VCR's. A CCTV system utilising DVR storage provides a multitude of advanced functions over VCR technology including video searches by event, time, date and camera, being the most preferred arrangement. This provides an interface for the software system needed to query the database with data from consumer text messages. The archive functionality ultimately provides a means of isolating the relevant video portion by time and camera.

### Storage Settings

The DVR can be set to store e.g. 25 frames every second providing video imagery seen by the human eye as a moving picture with no noticeable flicker. This is known as ‘real time’ and gives a picture similar to that of broadcast TV. The required storage space may be reduced by recording in time lapse mode, where fewer frames are stored during every second. For example, when recording video footage at 20 frames per second, it would require 20% less storage space than the aforementioned setting, hence reducing associated cost.

Current mobile phone video rarely ventures above 15 frames per second, therefore content may be stored in a lapse mode at this frame rate. This would take care of much of the compression before the data is written to the hard drive, hence significantly saving on storage costs. The capture frame rate could be increased/edited as mobile technology advances to correspond with industry trends, ensuring that playback matches handset/network capabilities.

The disadvantage of saving footage with lower frame rates initially is that is will render legacy footage to be of comparatively lower quality as technology advances, leaving limited value beyond the life of current handset/network capabilities. Therefore, it is preferred that the video imagery content is stored in a high quality compression format such as MPEG-4 at 25 fps, whereby legacy footage offers consistent quality regardless of mobile network advances in the future.

### Operating System

DVRs within CCTV systems may be categorized as being either PC based or embedded. A PC based DVR's architecture is part of a standard personal computer with video capture cards designed to capture video images. An embedded type DVR is specifically designed as a digital video recorder with its operating system and application software contained in firmware or read only memory. The type of operating system will depend upon the model selected, however it would be preferable if it was PC based to ensure maximum flexibility for upgrades and modifications. Considering that the present system can provide a high level of customisation and integration with bespoke application/event software components, whilst embedded such systems may work they are less preferred.

### DVR Preferences:

The following preferred features may be present within the DVR of the present apparatus and system:
(a) Design for rack mounting or desktop configurations as operational space dictates within stadiums.
(b) Multiple video inputs with connector types consistent with the analogue or digital video provided such as coaxial cable, twisted pair or optical fibre cable. The most common number of inputs are 1, 2, 4, 8 and 16. Significantly more inputs may be required for bespoke software systems.
(c) The DVR should be able to slot into a scalable system. Many DVRs may be configured with a very large number of inputs by networking or bussing individual DVRs together.
(d) Controlled outputs to external video display monitors.
(e) Control panel switches and indicators that allow the various features of the machine to be controlled, preferably through a software program.
(f) Network connections consistent with the network type and utilised to control features of the recorder and to send and/or receive video signals.
(g) Connections to external control devices such as keyboards. The keyboard mentioned (C-DKBD) has native integration with the ZR-DHD1621NP DVR.
(h) A connection to an external desk with pan-tilt-zoom facility to drive that position cameras.
(i) CD, DVD, VCR devices for archiving video on physical media.
(j) Connections to external storage media. This will provide contingency for back up storage should be DVR hard drives fail.

Taking these factors into consideration, it should be considered that no DVR will offer plug and play functionality into any system. Particularly multiple DVRs may be installed, configured and customised to work as part of a bespoke unit to archive the video content in the repository.

Having considered a number of DVR models, the ZR-DHD1621NP is a suitable model. The number required will depend upon the size of a stadium, and hence the number of cameras installed. For example, for the estimated 426 camera inputs required at Villa Park, 27 DVRs will be required if the 16 input model is selected.

### Storage Space

There are many variables which influence required storage space for any given embodiment of the present invention. For example, some cameras may use motion detection and may not record if a certain section of the crowd is empty, saving significant hard drive space. Also, a process may be in place whereby recording is only started depending on events on the pitch.

For the purposes of providing indicative calculations, the amount of storage space required for a given embodiment will be considered as indicative illustration of potential storage requirements.

If 426 cameras stored 100 minutes per match at a bit rate of 1 Mbps, then:

6000 seconds at 1 Mbps=732.421875 MB per camera, per match.
426 cameras×732.42 Mb=304.7 GB of storage space required per match.

Considering that the largest hard drive available in the ZR-DHD1621NP is 1.2 terabytes, one of these DVRs would reach capacity after 4 matches. Therefore significant additional external storage should be factored into the build of this system.

DVRs can be set to overwrite the oldest security footage should the disk become full, however this is ideally avoided if footage is to be archived from all football matches so that they can be accessed at any point in the future.

### Cabling

Each entity will require a physical connection to the next, implying a significant amount of cabling. The principal cable forms used in CCTV systems are co-axial cables and Category 5 (Cat 5).

### Co-Axial Cable

This is the most widely adopted method of carrying CCTV video signals. Coaxial cable is an electrical cable used as a high-frequency transmission line to carry a high-frequency or broadband signal. Because the electromagnetic field carrying the signal exists only in the space between the inner and outer conductors, it cannot interfere with or suffer interference from external electromagnetic fields.

Co-axial cables can transmit data up to about 300 m in distance. This may be sufficient for smaller stadiums.

### Cat 5

Category 5 cable, commonly known as Cat 5, is a twisted pair cable type designed for high signal integrity, and is a communications cabling form adopted by the CCTV industry. It is often used in structured cabling for computer networks such as Ethernet, and is also used to carry many other signals such as basic voice services, token ring, and ATM (at up to 155 Mbit/s, over shorter distances), being a more preferred form of cabling.

Cat 5 cable is also capable of carrying the CCTV signals far greater distances than co-axial cable, reaching up to 1,000 metres. In order to ensure maximum future proofing for larger stadiums, Cat 5 is the preferred option which offers greater flexibility and performance.

Below is an example of different cabling options.

Single Channel passive—Single channel interface from camera to Cat 5 cable with a maximum distance of 200 meters.

4 Channel passive—4 channel interface from Cat5 cable to control equipment with a maximum distance of 200 meters.

16 Channel passive—16 channel interface from Cat 5 cable to control equipment with a maximum distance of 200 meters.

Single Channel active—Single channel interface from camera to Cat 5 cable with a maximum distance of 600 meters. Active device 12V dc required.

4 Channel active—4 channel interface from Cat 5 cable to control equipment with a maximum distance of 600 meters. Active device 12V dc required.

16 Channel active—16 channel interface from Cat 5 cable to control equipment with maximum distance of 600 meters Active device 12V dc required.

### Wireless Technology

Although camera operators doing live broadcasts from the field used to have to be hard wired to a productions truck, today's cameras can be equipped with an RF (radio frequency) transmitter. The camera signal is transmitted to the production truck where it appears on a monitor just like any other source of video. These units are commonly used to allow camera operators to freely roam to acquire difficult shots.

However, the sheer scale of a single installation of the present invention means that wirelessly transmitting all of the video data from 426 cameras in such a concentrated space is not feasible. The technology can be subject to interference and higher failure rates, and sending faulty videos to customers is completely undesirable.

### Bottleneck Issues

The internet is a public network subject to constant variation in performance to end users. If a user in France tried to access content from an embodiment of the present invention hosted solely in the UK, it is likely that the data transmitted would encounter a potential delay along the way. This is not so detrimental for e-mails and documents where users can tolerate delays of up to several minutes. However, where applications such as time critical video download are concerned, any major latency can be critical. Ultimately, the further away the user is from the physical location of the server, the more router hops the content will likely have to take, and an ever increasing chance of delays. A way round this is for the present invention to utilise edge server technology.

### Edge Servers

One way around the issue of bottlenecks is to use edge servers. These are servers which cache the video content on the edge of a network in strategic points in close proximity to the internet backbone. This means that users in Europe for example can access the server in the UK without the content having to travel along often crowded networks. The video still requires hosting on the present servers, however the same data are held close to the network edge to ensure faster delivery to users.

### Server Redundancy

It is preferred to run an identical service from several servers to minimise potential downtime. While the primary servers are functioning adequately, the traffic can be load balanced to ensure that resources are utilised optimally. When circumstances arise where one server requires upgrading or maintenance (as often occurs), one of the servers can remain running during the downtime. In instances where only one server is deployed, the service will have to be removed completely while modifications are, meaning total service downtime and a subsequent loss of revenue.

### Server Farms/Hosting

The data and video accessed by users will be subject to costs for the amount of data transferred. There are three options available for this:
a) Dedicated line—Local ISP's can provide uncontended internet connections for businesses. For example, a 10 Mbps line. This provides a direct route to the internet backbone which would be for the exclusive use of the present system's own users, meaning that network traffic would not be subject to interference by third party traffic.
b) Contended line—This arrangement involves sharing an internet connection with a specific number of users. For consumer lines, this is generally a ratio of around 20:1, meaning that the Internet connection is shared with 20 other users, with congestion fluctuating as a result of this. This can be reduced to around a 5:1 contention ratio, with an increased cost, however this would still prove significantly cheaper than the dedicated line option.
c) Server farm—The servers can be located on a site with servers from other companies. The providers for this kind of arrangement generally house their own dedicated internet connection, often running up at speeds of up to 100 Mbps. Each customer has a data transfer usage cap, with additional charges made for those exceeding this.

Considering the amount of data being transferred and the need for fast turnaround times, the best option is setting up a dedicated line for the system at each stadium. This will provide a guaranteed route to the internet backbone without fear of congestion which can hinder the videos reaching customers.

### Software Requirements Overview

Video content can be difficult to manage and index effectively. The present invention benefits from an efficient content management system (CMS), to locate, access, and deliver the correct video to the user in a timely manner.

Failures to locate the requested footage typically results in a lost customer, and consistent failure to achieve this should be avoided. Therefore engineering a suitable CMS and mobile server application is a highly desirable requirement of the system.

The way in which the CMS applies metadata to the files and then indexes them will determine the speed at which they can be retrieved from the video repository. Generally speaking, tagging and describing rich media is still a manual process, meaning that the process of defining and describing video content still requires humans manually to enter information. A manual approach can result in a two or threefold increase in overall processing time, thus eroding efficiencies.

In summary, a content management solution is desired that resourcefully stores, categorizes, manages, retrieves, and then outputs video and audio as requests are received.

The software applications preferably collectively include the following capabilities:
(a) User selectable image capture rates either on an all input basis or input by input basis. This means that different capture frame rates could be set for individual cameras/sections of the crowd.
(b) The capture frame rate and image resolution feature may be programmed to automatically adjust the capture rate on the occurrence of an event. For example, if a team is in possession in the opposition half for the final third of the pitch, the capture rate could be increased from 15/20 fps to 25 fps. This will cover the vast majority of clips ordered, and would significantly reduce the amount of storage space required.
(c) Selectable image resolution either on an all input basis or input by input basis. This can also be triggered to change by an event/signal.
(d) For embodiments of the system which are entirely automated, motion detection could be a possible solution. Using motion sensors, cameras can start and stop recording according to the amount of activity in a scene. In a football stadium, recording would probably begin around one hour before kick off and cease around 30 minutes afterwards.
(e) Motion detection can be a prompt to start and stop recording. This is not strictly necessary, however it would offer significant savings on storage space.
(f) Routing of input video to video monitors based on user inputs or automatically on alarms or events.
(g) Input, time and date stamping.
(h) Event logging on appropriate video inputs.
(i) Searchable index of events.
(j) Ability to process requests to and from mobile devices.
(k) Intelligently recognise the model of the device and the natively installed video players.
(l) Encode and distribute video according to the handset which originated the request.

### Load Balancing

Deploying multiple servers optimises performance by distributing the incoming traffic across supporting servers. Before the primary server reaches a stage where performance becomes compromised, traffic can be distributed to additional servers so that any risk of crashing is minimised.

If a server is overwhelmed with requests for a particular file for example, it can crash and result in needing to be restarted. This is particularly common with popular videos where projected user requests have been underestimated.

A load balancer is preferably provided to receive and analyse requests from users and pass these onto the server with most capacity to respond. When all servers reach 100% capacity, no further requests can be taken and subsequent users will receive an error message from the service.

### Payment Processing System

There are at least two different methods that can be adopted for the present system, namely, payment via credit/debit card for internet users, or payment via mobile phone. There are other methods available such as online virtual payment providers (digital money or e-wallets).

In order to facilitate these a gateway is required in order for the transactions to be accepted, and in the case of credit/debit cards, a gateway will connect a chosen payment type to the system merchant account within the bank.

The payment system can be part of a package already in place or available e.g. as part of a interactive system or as part of a TV with a dedicated interactive channel.

### Internet Merchant Account

An Internet Merchant Account with an acquiring bank is required if payment by credit/debit card is needed to be taken online. The acquirer authorises the purchases made with the credit card and ensures that the funds are deposited into the merchant's bank account. In the case of payment by SMS, this is unnecessary as the payment gateway will generally by directly by cheque or BACS.

### Preferred Gateways

A gateway will connect the systems payment system to the online/internet merchant account with the bank.

Typical gateways facilitate payments online by connecting systems with a specific merchant account at a processing bank. The gateway takes the submitted data and presents it to the processing bank. It then receives a response from the bank, and presents that return data to the system for handling e.g. depending on whether or not the sale has been accepted.

Using mobile SMS, the payment service provider is generally still referred to as a gateway, there is in most cases no link to a merchant account as the gateway/service provider will pay directly once acknowledgement of funds transfer has been received from the mobile network providers.

The gateway itself does not provide e-commerce features typically seen on websites, such as shopping carts nor will it provide a needed merchant account. However, many larger gateway providers, especially in the realms of credit/debit card gateways will offer packaged services, so the present system may be able to pay one provider to deliver this component of the system in its entirety.

### Criteria for Selection

Some important factors that are to be considered, amongst others, when selecting and implementing an appropriate gateway are:
(a) Available features
(b) Cost
(c) Reliability
(d) Payment method

One of the main concerns for all parties involved in an e-commerce transaction is security. Not only is customers' sensitive information kept on file, but other personal information will pass through the gateway every day, especially when dealing with credit or debit card transactions. This information is of considerable value to hackers, so it must be protected.

Overall, the majority of top gateway providers will actually house their servers in sate-of-the-art data centres, and use cutting edge security methods to keep data safe, so the chosen provider should offer agreeable service level agreements and assurances for their services.

### Features

Most gateways will offer more features than the ability to just accept credit cards through an online form. In today's market, gateway providers tend to offer value-added features that can help increase revenue streams.

Recurring Billing
This can be a big time-saver when charging customers on a periodic basis, such as a subscription model (a possibility of a system season ticket for example). By using recurring billing, billing information can be provided to the gateway along with how often to charge. This feature is intended for subscription and membership based businesses, however can be built into systems which use one off transactions also.

Integration
Integration is consideration when a gateway is being chosen. This really revolves around whether or not it is intended for the checkout process to be completely transparent to customers, or whether or not integration into the existing interface and associated branding is required.

Reliability
The gateway should be up and running 24-7, with relatively little loss of service. Therefore Service Level Agreements (SLAs) and uptime guarantees should be provided.

### Payment Methods

There are various suitable payment methods depending on the charge per transaction and the intended target audience.

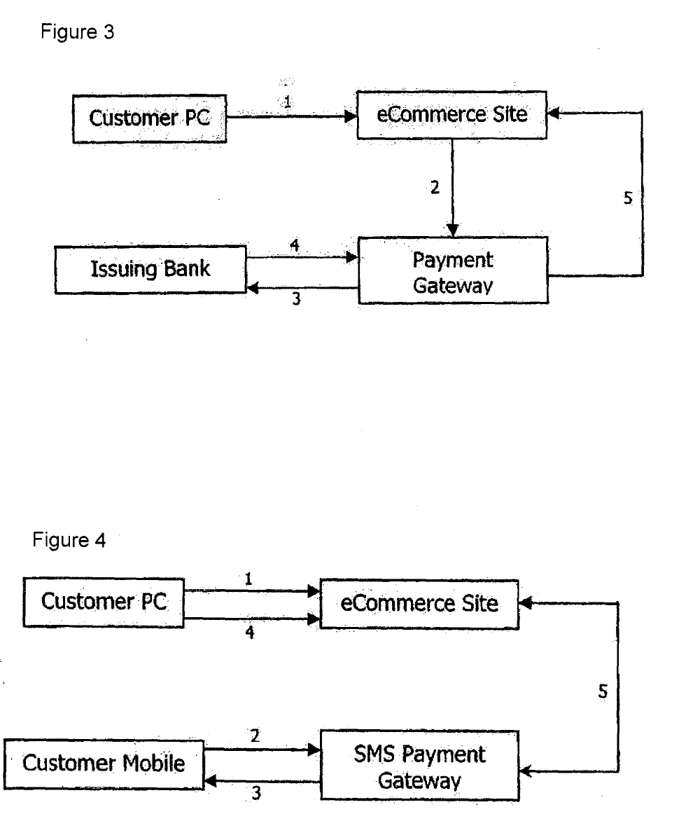

Credit or Debit Card
Accepting payment by credit or debit card through an associated website has its advantages over most other payment solutions. Not only is this because of the widespread use of credit/debit cards, but the associated trust factor. More people are buying online using this option than were ever before.
On of the main benefits of credit cards, for both buyer and seller, is that the transaction is instantaneous as is funds release. Customers do not need to complete any additional steps to finalize their purchases i.e. as in the case of SMS payments. Security has been improved greatly both in accepting transactions and in transfer of information and its storage. Not only that, but unlike SMS payments, a greater amount of flexibility is present in terms of pricing structures. This has to be kept in mind when evaluating the alternatives to credit cards.
The transaction process can be shown as indicated in FIG. 3:
1. Customer submits his credit card information at the checkout of the Website.
2. The shopping cart software sends the transaction to the gateway.
3. The gateway, acting as a credit card processor contacts the bank that issued the customers credit card.
4. The issuing bank approves or declines the transaction.
5. The gateway then passes the result back to the Website shopping cart system.

A lot of gateways that provide payment by credit or debit card, as is most common, are also compliant with the security initiatives put forward by the major credit card providers. These include Visa Cardholder Information Security Program (CISP), MasterCard Site Data Protection (SDP), and Discover Information Security and Compliance (DISC). This gives a greater sense of security to the purchaser and has led to far more people using credit cards online that would have done so before.

### Payment Using Mobile Phone (SMS)

The primary payment method is preferably via mobile phone and more specifically, SMS. Mobile phones use micro-payments, and in particular, premium priced SMS messages.

From a customer point of view, micro-payment via SMS is as simple as paying with a credit card in a supermarket. The mobile phone acts as a credit card—and the mobile operators act as a bank. The basic transactional process can be illustrated as shown in FIG. 4:

### Choosing Clip/Footage of Video Imagery to be Displayed

The remote viewer needs a mechanism to choose the appropriate viewing clip. This will depend on the seat number of his/her friend. If the friend is a season ticket holder he will need to be allocated and informed of a seat identifier (typically shared by a number of surrounding seats that are observed by the same camera). This can be sent to each season ticket holder via email or normal mail. If the friend has a ticket to just that event, then identifier information has to be mailed to the friend along with the ticket or be printed on the ticket itself. In both cases the friend will have to pass this on to prospective viewers.

Additional codes will be needed to identify interesting events such as ‘goal 1’, ‘penalty 1’, ‘booking 1’, ‘near miss’, etc. Or time in match such as ‘30 mins’, etc.

In the mobile scenario these identifiers would have to be sent to the SMS-Short Code.

In the Web scenario these identifiers would need to be sent to the webserver.

In the TV scenario these identifiers would need to be sent via the return path to the TV head.

Alternatively the friend or remote viewer could access a website to find this identifier. The web interface is also important for viewing archived content. This will be by use of calendars, menus and/or diagrams of the stadium layout.

The procedure for mobile phone access may be briefly summarised thus:
1. Customer Visits site and obtains details on how to pay for content.
2. Customer sends the unique seat identifier to the SMS-Short Code (e.g. DERGS4623).
3. Customer receives video link for download. Amount is charged to their mobile phone account and payment is authorised instantly.

One of the unique factors of payment by premium SMS solution is its user-friendliness due to its speed. Also the fact that the customer does not need to invest in new technology and neither is there a need for the customer to share credit information with third parties.

The use of SMS as a payment solution can go a long way to building trust as it involves established and trusted third parties, the mobile operators.

Another perceived benefit the customer sees is that since premium priced SMS messages are priced according to pre-arranged categories, it is not possible for the site to over charge the customer without his consent.

### Maintenance and Compliance

As with all electrical installations there are a number of issues which should be upheld. These concern the handover of the system to the client and the establishment of a maintenance schedule.
The handover of the system on completion involves:
   (a) Going through the system specification in detail
   (b) Identifying the data in the documentation
   (c) Showing the location of each item of equipment
   (d) Indicating the view of every camera
   (e) Demonstrating the use of the system
   (f) Illustrating the recording procedures
   (g) Activating all equipment
   (h) If telemetry is included demonstrating all aspects of its role
The Maintenance of the System Should:
   (i) Be based on the BSIA Code of Practice
   (ii) Be made within 12 months of the completion of the installation (known as a Level 1 visit since it is a basic requirement)
   (iii) Involve a check to verify that the system complies with the system specified at the original handover
   (iv) Confirm that the quality of the image from every camera is satisfactory
   (v) Prove that environmental changes have not been made that can have an effect on the system

The system and apparatus of the present invention can be used, if required, to provide or enhance security measures in that images of people within selected regions of or near e.g. the stadium can be captured for subsequent replay e.g. for use by security staff, authorities, police or in court. For instance CCTV cameras can be stationed at or near entrances and exits and can be used to monitor the behaviour of persons or groups of persons leaving and/or entering e.g. the stadium, or images of people in other specific areas of the spectator stands can be monitored and replayed. The system can be used to monitor for the possible presence of banned individuals.

Where the major spectator event is, for example, a concert the arena may be divided into zones identified by unique colour e.g. columns may be coloured red, green, yellow and the like and the arena may be further sub-divided into blocks such as BLOCK A, BLOCK B, BLOCK C and the like. Such blocks can be further sub-divided into rows of seats. To recall video imagery of one or more spectators at an event recorded by CCTV cameras according to the present invention, and have the recalled imagery displayed to a mobile phone, then the person requesting the imagery can key in identification information according to the zone, block and seat row/seat numbers to be sent via SMS text message to the mobile operator. It will be helpful to the system for seat numbers on the seats and/or tickets to be clearly visible so that the spectator/fan clearly recalls their exact location to be transmitted to the video archiving means.

In order that the invention may be illustrated, more easily appreciated and readily carried into effect by those skilled in the art, embodiments thereof will now be described purely by way of non-limiting example with reference to the accompanying drawings, wherein:

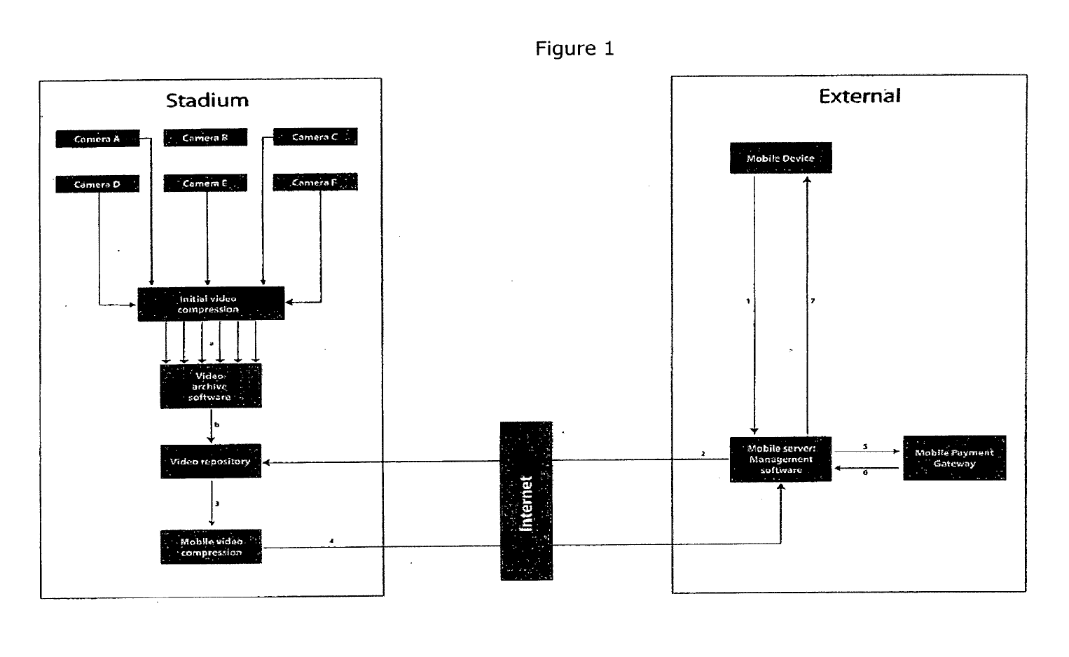

FIG. 1 is a schematic block diagram and flow chart identifying the components of one preferred system based on displays to mobile phones and their relative inter-connection,

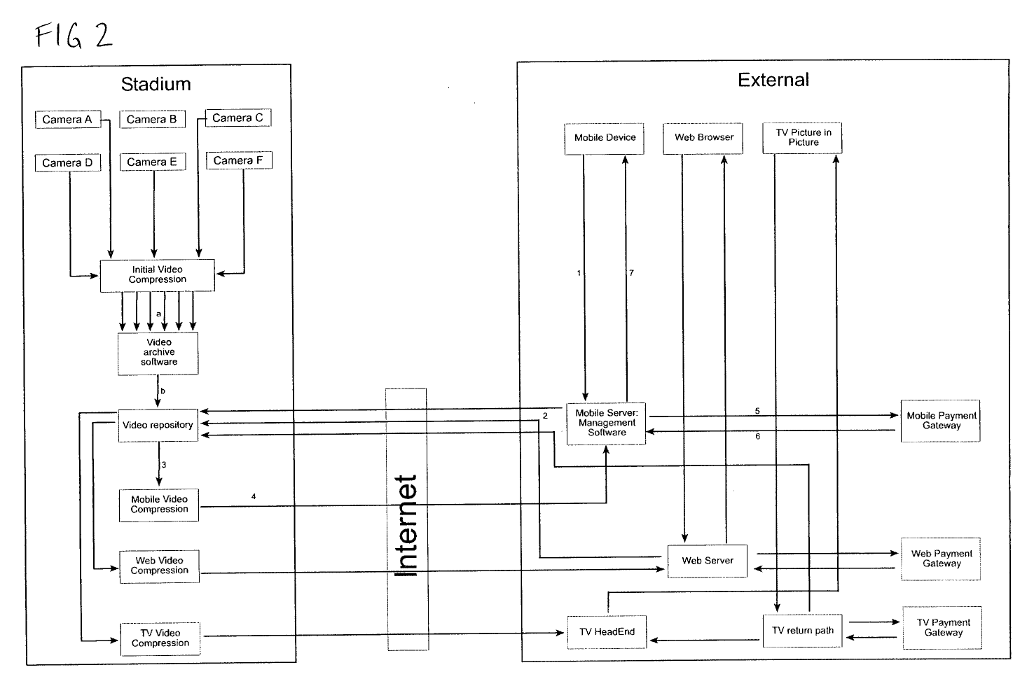

FIG. 2 is a similar block diagram and flow chart including additional facilities and functions enabling displays to a computer screen via web browser and/or TV screen via a TV Head.

FIG. 3 is a short block diagram depicting a suitable payment system for web browser and TV display applications, and

FIG. 4 is a short block diagram depicting a suitable payment system for mobile device applications using an SMS gateway.

Referring to the drawings, there are shown in FIGS. 1 and 2 two examples of a suitable operational system for displaying upon request specific archived video imagery of a spectator or group of spectators during, e.g. sporting events such as the scoring or prevention of a goal in football. This is but one of many potential end use applications.

### EMBODIMENT OF METHOD OF OPERATION

Referring to the schematic drawing:
1. A customer sends a text message with a unique identifier (e.g. metatag) to the mobile server.
2. The server sends a request across the internet to query the video archive.
3. The archive sends the video to be compressed into a suitable mobile device format.
4. The file is sent across the internet back to the mobile server.
5. Payment is deducted from the user's account.
6. Acknowledgement of successful transaction sent to the mobile server.
7. Video sent to the originating user.

### DETAILED EMBODIMENT

Below are specifically selected components useful in capturing suitable video imagery of spectators at a stadium with 42,573 capacity.

SYSTEM COMPONENT

Installation
426 cameras
Lighting
8 AM-L219P Display monitors
27 DVRs
Server hardware
Multi-format intelligent device
recognition mobile encoding software
Private 10 Mbps internet connection
Mobile gateway
Content Management System
Hardware maintenance/upgrade
(annual)
Software maintenance/upgrade
(annual)
E-commerce

### Video Acquisition

(a) When selecting a lens it is important to understand the significance of the angle of view and the lighting.
(b) Any part of the stand permanently subject to poor illumination should be remedied by additional lighting rather than seeking to address the problem through the camera.
(c) When natural light is not available, artificial light should be provided since poor illumination will result in low quality video.
(d) Natural light may suffice during daytime matches; however evening events will likely require additional illumination, especially on isolated parts of the crowd.
(e) A balance should be struck between providing adequate lighting for the cameras for a full colour image, and ensuring that the experience of the football match is not intruded upon.
(f) Placement of the cameras as this is an arbitrary consideration which will vary in every stadium.

### Video Delivery Summary

(a) Delivering video across the internet/mobile networks requires significant compression.
(b) In order to reach the widest possible mobile audience, it is preferred to encode the mobile videos in a variety of codecs and formats.
(c) Unlike PC-based offerings where it is possible for the user to download additional software to view the content, mobile phones are fairly limited in CPU and memory, so application downloading is not widespread.
(d) Not all phones have native support for video playback.
(e) Updated software can and does make it into the marketplace in shorter cycles on mobile phones than for embedded systems.
(f) Most content providers in the mobile space are using MPEG-4 as their video codec for 3GPP content, which is currently the most suitable option assuming that as wide an audience as possible is to be targeted.
(g) H.264 provides high image quality for a given data rate and is expected to have a player installed as standard for videophones in the near future.
(h) It is advisable to encode in 3GPP video to ensure support for the current market as widely as possible.
(i) While Pocket PC and Palm-based phones are gaining market share, regular mobile phones make up the vast majority of devices in circulation, and the current prices of both will see this trend continue for the near future at least.
(j) There are many codecs and formats, which could be supported.
(k) One of the fundamental features of the system is that the user may keep content for as long as they please.
(l) Content download ensures a higher quality experience for the end user. In this scenario, every piece of content and can be downloaded and stored in the phone's memory.
(m) Handset manufacturers will raise the amount of storage in phones to meet the increase of download content available on the market.
(n) If the system acquires accurate usage information, the operator can ensure most efficient delivery of the content, and the fans get the best possible experience from having the content served topologically closest to them.

### Hardware Requirements Summary

(a) Considering that significant storage capacity will be required, a codec such as MPEG-4 is preferred to archive video content.
(b) A CCTV system utilising DVR storage provides a multitude of advanced functions over VCR technology including video searches by event, time, date and camera, which is the most preferred camera system.
(c) A good way of reducing the required storage space is to record in time lapse mode, where few frames are stored during every second.
(d) Current mobile phone video rarely ventures above 15 frames per second, therefore it may be worth considering the possibility of storing content in a lapse mode at this frame rate.
(e) Considering that the system will require a high level of customisation and integration with bespoke system software components, it is preferred not to restrict the system into the constraints of embedded systems where the functionality is locked.
(f) Multiple DVRs may have to be installed, configured and customised to work as part of a bespoke unit to archive the video content in the repository.
(g) Significant additional external storage may be required for the system.

### Physical Infrastructure Summary

(a) Cabling is an integral part of the system and needs sufficient investment at the installation stage in order to cover the distances required in the stadiums.
(b) Edge server technologies may be deployed to serve content in other countries.
(c) The sheer scale of a single client installation dictates that wirelessly transmitting all of the video data from 426 cameras in such a concentrated space is presently not feasible.
(d) It is advisable to run an identical service from several servers in order to protect against any potential downtime.
(e) Considering the amount of data being transferred and the need for fast turnaround times, a preferred option is a dedicated line for the system at each stadium.

### Software Requirements Summary

(a) An efficient content management system (CMS) is desired to locate, access, and deliver the correct video to the user in a timely manner.
(b) Engineering a suitable CMS and mobile server application will be required.
(c) The efficiency of the way in which the CMS applies metadata to the files and then indexes them will determine the speed at which they can be retrieved from the video repository.

### Payment Processing System Summary

(a) Many larger gateway providers, especially in the realms of credit/debit card gateways offer packaged services, so the present system can select one provider to deliver this component of the system in its entirety.
(b) When a gateway provider is chosen, the public should see that robust security is one of the key strengths.
(c) The chosen provider should offer agreeable service level agreements and assurances for their services.
(d) Recurring billing could be used to charge customers on a periodic basis, such as a subscription model (a possibility of a system season ticket for example).
(e) It should also be checked, especially if taking credit/debit card payments whether or not the payment gateway will charge for pre-authorisation or failed transactions.
(f) Mobile phone use micro-payments, and in particular, premium priced SMS messages.
(g) The use of SMS as a payment solution helps build trust as it involves established and trusted third parties, the mobile operators.

### Recommendations on the Construction, Set Up and Operation of Embodiment

Any CCTV system is made up from a number of components that themselves must be installed in accordance with certain practices if the final system is to work as intended. The guidelines below will help obtain optimum results from the system.

Initially, a trial run can be set-up and operated in a smaller stadium before transferring the system into a larger stadium taking account of the following parameters.
(a) Preferably install the external cameras under a soffit or in a sheltered location that does not suffer the full force of the rain.
(b) Cameras should not be pointed directly towards sources of light including street lights and floodlights and strong light sources in the picture should be avoided.
(c) The max. distance of IR illuminators is 10 m. We prefer a max. distance of 6 m.
(d) Equipment and components should be installed on a secure fixing not subject to vibration.
(e) Cameras should be fixed to a secure point not subject to vibration.
(f) The focal length of the lens can be adjusted to a small margin during the installation process and then set to give the optimum angle of view at the monitor.
(g) All connections should be connected correctly and secure in weather-resistant junction boxes and the cabling can be installed in accordance with the relevant electrical standards for cable installations.
(h) All connections should be connected correctly and secure and in an appropriate junction box.
(i) Cat5 cable is the most preferred cable.

### General Guidelines

Camera/Lens
(a) Install the camera in a sheltered location.
(b) Set up and adjust the camera to acquire a good view of the target area.
(c) Never point the camera at windows, doors or strong sources of light.
(d) Don't subject external cameras to the full force of the rain.
(e) Check with camera specification to establish if it is to be powered locally at the camera head or at the control point using the system power supply.
(f) Always record every camera position in the system log and of the scenes.

Cables
(a) Cat5 is a networking cable used to transmit the video and power. This facilitates a fast and easy installation. It can be terminated with RJ45 connectors.
(b) Ensure that the cables are secure and can not be disturbed at the control point location.
(c) Install the cables in accordance with relevant electrical standards and wiring regulations.
(d) Don't use standard twisted pair, multicore or screened cable as an alternative to Cat5 cable.
(e) Never stretch or bend any cables excessively.
(f) Cabling longer than the maximum distance specified for the system should not be installed i.e. the cables running between the cameras and control point DVR.
(g) A supplied adaptor and a power cord should be used for the DVR at the control point.
(h) Observe proper connection of the cameras (video sources) when connecting them to the video input terminals.
(i) Observe proper programming of the DVR. In particular select the most appropriate recording mode and quality of the recording images.
(j) Use the External I/O for control remotely by an external device or control system such as a video web server.
(k) Ensure that the monitor termination witch is correctly set.

Recording and Monitoring
(a) Only use the supplied adaptor and power cord for the DVR at the control point.
(b) Observe proper connection of the cameras (video sources) when connecting them to the video input terminals.
(c) Observe proper programming of the DVR. In particular select the most appropriate recording mode and quality of the recording images.
(d) Use the External I/O for control remotely by an external device or control system such as a video web server.
(e) Ensure that the monitor termination switch is correctly set.
(f) Provide for system expansion when selecting the DVR. Select the correct number of video signal channels.
(g) Brightness and contrast should be set at the monitor so that the viewer can see as many picture details as possible.

Lighting/Illumination
(a) Provide even illumination over the scene.
(b) Recognise the quoted range for external cameras with infra red illumination.
(c) Ensure that artificial lighting is installed for those periods when natural light is not available.
(d) Don't let the camera view the light source direct as this will cause bright patches or light spots.
(e) Don't use manual iris lenses with installations which have changing light levels.

Specify an auto iris lens as the preferred selection.

1-12. (canceled)

13. A system arranged to display upon request video imagery stored in a video archive of an attendee at an event, the system comprising:
(a) a plurality of cameras arranged to capture video images of the facial expression(s) of an attendee viewing an event;
(b) primary video compression means adapted to compress video images received from cameras (a);
(c) video archiving programming means arranged to process video signals compressed by the compression means (b);
(d) video archiving means arranged to store said compressed video signals;
(e) secondary video compression means linked to the video archiving means (d) and adapted to compress video imagery obtained from said video archiving means (d) into a format selected from a mobile device format, web video format and TV video format;
(f) server means adapted to said format and arranged to interrogate said archiving means (d), and capable of communication with (g) a remote mobile device, web browser or TV display controller and with (h) a payment gateway appropriate to said format, and in which archived video images are compressed and relayed to said server means (f) and subsequently to said mobile device, web browser or TV display controller (g) upon demand from said server means when triggered by a request from any of said remote mobile device, web browser or TV display controller (g) for specific video imagery once authorized by said payment means (h).

14. A system as claimed in claim 13 wherein said server (f) is linked in communication with said video archiving means via an internet or similar publicly accessible network connection.

15. A system as claimed in claim 13 wherein said secondary video compression means (e) is linked in communication with said mobile device server via an internet or similar publicly accessible network.

16. A system as claimed in claim 13 wherein said remote mobile device, web browser or TV display controller (g) is arranged to interrogate the device server means via a text message incorporating a unique identifier associated with the said specific video imagery to be requested from the video archiving means (d).

17. A system as claimed in claim 13, wherein the server means (f) are adapted to TV format.

18. A system as claimed in claim 17 wherein the TV format is arranged as a small window within the overall TV picture.

19. A method of displaying video imagery of an attendee at and viewing an event upon a mobile electronic display device, using a system as claimed in claim 13, wherein
(i) a text message comprising a unique identifier associated with specific video imagery to be displayed on said mobile device is relayed to server means (f);
(ii) the said server means (f) transfers a request to interrogate the video archiving means (d) and locate the required specific video imagery;
(iii) the video archiving means (d) converts the specific video imagery to be compressed into a suitable format file for said mobile device;
(iv) the compressed file obtained in step (iii) is relayed back to said server means (f);
(v) payment for the specific video imagery requested is deducted from the mobile device user's account;
(vi) indication of accepted payment is relayed to the said server means (f), and
(vii) the requested specific video imagery is relayed to and displayed upon the said mobile device.

20. A method as claimed in claim 19, wherein the request to interrogate the video archiving means in step (ii) is effected through an internet or similar publicly accessible network connection.

21. A method as claimed in claim 19, wherein transfer of the compressed file in step (iii) is effected through an internet or similar publicly accessible network connection.

22. An arena or stadium comprising a plurality of seats for attendees and having the system of claim 13.

23. An arena or stadium as claimed in claim 22, wherein the attendees are seated in the seats and the cameras are arranged to capture video imagery of each attendee in their respective seat.

24. A method of displaying imagery of a specific attendee at and whilst viewing an event, the method comprising:
a) capturing images of an attendee viewing an event using a camera;
b) compressing the images received from the camera;
c) processing the compressed images
d) archiving the compressed and processed images;
e) compressing images obtained from said archive to provide images in a format compatible with a format selected from a mobile device format, web video format and TV video format;
f) interrogating said archiving means using a server, said server being able to communicate with a remote mobile device, web browser or TV display controller and capable of communicating with a payment gateway, said server means being in communication to receive compressed images and relay the same to a mobile device, web browser or TV display controller; and
g) delivering specific archived images of an attendee to a mobile device, web browser or TV display controller, upon request from any of a mobile device, web browser or TV display controller once authorized by payment means.
